(19) United States
(12) Patent Application Publication
(10) Pub. No.: US 2023/0064674 A1
(43) Pub. Date: Mar. 2, 2023

(54) ITERATIVE TRAINING OF COMPUTER MODEL FOR MACHINE LEARNING

(71) Applicant: International Business Machines Corporation, Armonk, NY (US)

(72) Inventors: Holger Koenig, Boeblingen (DE); Lars Bremer, Boeblingen (DE); Manfred Oevers, Tuebingen (DE); Martin Oberhofer, Sindelfingen (DE)

(21) Appl. No.: 17/446,465

(22) Filed: Aug. 31, 2021

(51) Int. Cl. G06N 5/02; G06N 5/04

(52) U.S. Cl. CPC G06N 5/022; G06N 5/04

(57) ABSTRACT

The present disclosure relates to a computer receiving a current training dataset. A first fraction of the training dataset comprises synthetic training data and a remaining second fraction of the training dataset comprising real-life training data. The real-life training data is user defined data and the synthetic training data is system defined data. A machine learning based engine is trained and may repeatedly be performed by using the current training dataset. In each iteration or a subset of the iterations, the training dataset is updated by adding real-life training data, thereby increasing the second fraction in the updated training dataset and reducing the first fraction of the synthetic training data.

### BACKGROUND

The present invention relates to the field of digital computer systems, and more specifically, to a method for training a machine learning based engine.

Clerical records are records for which a given matching process cannot determine if they are duplicate records to each other and hence should be merged or if one or multiple should be considered a non-match and hence should be kept separate from each other. Those clerical records may need a user intervention for a closer look into the values of the data records. Despite the tremendous efforts to automate and improve the process of record matching, the number of those clerical records is continuously increasing (e.g., it can be millions of clerical records). This results in most of the clerical records being not processed for a very long time period during which inconsistent data may be used in system configurations.

### SUMMARY

Various embodiments provide a method for training a machine learning based engine, computer system and computer program product as described by the subject matter of the independent claims. Advantageous embodiments are described in the dependent claims. Embodiments of the present invention can be freely combined with each other if they are not mutually exclusive.

In one aspect according to the present invention, a computer implemented method of training a machine learning based engine includes receiving a current training dataset. A first fraction of the current training dataset includes synthetic training data and a remaining second fraction of the training dataset includes real-life training data. The real-life training data being user defined data and the synthetic training data being system defined data. The method includes repeatedly training the machine learning based engine by using the current training dataset, wherein the training dataset is updated in each iteration or in each iteration of a subset of the iterations by adding real-life training data, thereby increasing the second fraction of the real-life training data and reducing the first fraction of the synthetic training data in the updated training dataset.

In a related aspect, the machine learning based engine is trained to determine whether two data records are duplicates with each other, and the method further comprising using the machine learning based engine after being trained to compare records of a database.

In a related aspect, the machine learning based engine is used to compare the records of the database if a prediction accuracy of the current trained machine learning based engine does not increase compared to the prediction accuracy of the trained machine learning based engine of the last iteration.

In a related aspect, the machine learning based engine is used to compare the records of the database if the first fraction is zero.

In a related aspect, the method further includes, in each iteration or in each iteration of the subset of the iterations, reducing the synthetic training data, thereby further reducing the first fraction of synthetic training data in the updated training dataset.

In a related aspect, the reduction of the synthetic training data is an absolute or relative reduction.

In a related aspect, the repeated reduction of the synthetic training data includes gradually reducing the amount of synthetic training data.

In a related aspect, the amount of synthetic training data is reduced up to a point where the training is performed solely on real-life training data.

In a related aspect the level of reduction of the synthetic training data used for training is dynamically adjusted based on at least one prediction quality metric.

In a related aspect, the second fraction is zero for the first execution of the training of the machine learning based engine.

In a related aspect, the machine learning based engine is a machine learning based matching engine for finding duplicates in databases, the training dataset comprising labeled records. The records of the synthetic training data are labeled by a rule-based matching engine based on a comparison of the records by the rule-based matching engine.

In a related aspect, the rule-based matching engine operates using deterministic matching and/or probabilistic matching.

In a related aspect, labeling synthetic training records includes using a default configuration of the rule-based matching engine.

In another aspect according to the present invention, a computer program product comprising a computer readable storage medium having program instructions embodied therewith. The program instructions are executable by a computer to cause the computer to perform functions, by the computer, comprising the functions to; receive a current training dataset, a first fraction of the current training dataset comprising synthetic training data and a remaining second fraction of the training dataset comprising real-life training data, the real-life training data being user defined data and the synthetic training data being system defined data; and repeatedly train the machine learning based engine by using the current training dataset, wherein the training dataset is updated in each iteration or in each iteration of a subset of the iterations by adding real-life training data, thereby increasing the second fraction of the real-life training data and reducing the first fraction of the synthetic training data in the updated training dataset.

In another aspect according to the present invention, a system of training a machine learning based engine includes a computer system, the computer system includes; a computer processor, a computer-readable storage medium, and program instructions stored on the computer-readable storage medium being executable by the processor, to cause the computer system to perform the following functions to; receive a current training dataset, a first fraction of the training dataset comprising synthetic training data and a remaining second fraction of the training dataset comprising real-life training data, the real-life training data being user defined data and the synthetic training data being system defined data; and repeatedly train the machine learning based engine by using the current training dataset, wherein the training dataset is updated in each iteration or in each iteration of a subset of the iterations by adding real-life training data, thereby increasing the second fraction in the updated training dataset and reducing the first fraction of the synthetic training data.

### BRIEF DESCRIPTION OF THE DRAWINGS

In the following embodiments of the invention are explained in greater detail, by way of example only, making reference to the drawings which include the following figures.

FIG. 1 is a diagram of a computer system in accordance with an example of the present subject matter.

FIG. 2A is a flowchart of a method for training a machine learning based engine in accordance with an example of the present subject matter.

FIG. 2B is a plot illustrating the reduction process of the synthetic data in accordance with an example of the present subject matter.

FIG. 3 is a flowchart of a method for matching data records of a dataset in accordance with an example of the present subject matter.

FIG. 4 is a flowchart of a method for training a machine learning based engine in accordance with an example of the present subject matter.

FIG. 5 is a flowchart of a method for inferring a machine learning based engine in accordance with an example of the present subject matter.

FIG. 6 represents a computerized system, suited for implementing one or more method steps as involved in the present subject matter.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

During the production and processing of data by a computer system such as mater data management (MDM) system, data may be stored and analyzed by users of the computer system. Although the amount of stored data may rapidly increase over time, the results of the analysis may increase very slowly over time. However, the customers may need to make use as early as possible of data being stored in order to improve the function of the computer system. In particular, the customers may need to label the stored data based on the analysis results in order to use that labeled data, e.g., as training data for training machine learning models. This may, for example, provide the customers with a systematic tool that can identify duplicate data in the computer system based on the data stored by the computer system so far. The present subject matter may solve this issue by using synthetic labelled data in combination with current accumulated real-life labeled data. For example, to bootstrap a new customer of the product that does not have real-life training data available, synthetic training data may be generated by labelling the data using a computer system solely. This synthetic training data is not generated based on user analysis results; rather it is based on system-based analysis. The present subject matter may enable a progressive training of the models based on the processing progress at the computer system. The training dataset being used is regularly updated with real-life data while the intermediated results of the training can still be reliably used to perform inference. For example, customers may collect, over time, more and more real-life training data during the stewardship process. This may enable to gradually reduce the amount of synthetic data during the training process. The real-life data may be referred to as natural data. The real-life training data may be defined e.g., labeled by a user e.g., steward. The user may analyze the data himself or herself and label the data based on his/her analysis. By contrast, the synthetic training data is system defined data (e.g., system labeled data) because it is defined by a system and not by a user. For example, the synthetic training data may comprise data that is labeled by a computer system based on analysis performed by the computer system. This labeling may, for example, be performed automatically.

The present subject matter may enable an active learning in which the generation of training data is controlled within an iterative training process. The term “active learning” is used herein to refer to an active generation of training data by the present method in order to train the machine learning based engine. This may enable to add valuable and/or informative records iteratively to the training set. The training dataset may comprise multiple entries, wherein each entry comprises a labeled data point. The data point represents multiple data records and the label indicates whether the multiple records of the data point are duplicate records or not. The label may, for example, have value “same” indicating that the records of the data point are duplicates or value “different” indicating that the records of the data point are not duplicates.

The machine learning based engine may be trained such that it may output a classification result for a given input data point. The classification result may comprise an indication of one or more classes in association with a probability that the input data point belongs to each of the one or more classes. For example, the higher the probability for class “same”, the higher the level of matching between the records of the data point and vice versa. And the higher the probability of a class “different”, the lower the level of matching between the records of the data point and vice versa.

The updating of the training dataset may be performed in each iteration/repetition of at least part of the iterations of the training of the machine learning based engine. For example, the updating of the training dataset may be performed in each iteration of the training of the machine learning based engine. In one example, the updating of the training dataset may be performed in each iteration of all iterations of the training of the machine learning based engine. Alternatively, the updating of the training dataset may be performed in each iteration of a subset of the iterations of the training of the machine learning based engine. The subset of the iterations may be selected iterations of the iterations of the training of the machine learning based engine. For example, the updating of the training dataset may be performed in each iteration of the selected iterations of the training of the machine learning based engine e.g., the updating of the training dataset may be repeated after training the machine learning based engine N times, e.g., if N=10, a new updated training dataset may be used for the 11^{th} training, the 21^{st} training etc.

The machine learning based engine may comprise a machine learning (ML) model. The term “machine learning” (ML) refers to a computer algorithm used to extract useful information from training data sets by building probabilistic models (referred to as machine learning models or “predictive models”) in an automated way. Machine learning algorithms build a mathematical model based on sample data, known as “training data”, in order to make predictions or decisions without being explicitly programmed to perform the task. The machine learning may be performed using a learning algorithm such as supervised or unsupervised learning, [clustering, classification, linear regression,] reinforcement algorithm, self-learning, etc. The machine learning may be based on various techniques such as clustering, classification, linear regression, support vector machines, neural networks, etc. A “model” or “predictive model” may for example be a data structure or program such as a neural network, a support vector machine, a decision tree, a Bayesian network etc. The model is adapted to predict an unmeasured value (e.g., which tag corresponds to a given token) from other, known values and/or to predict or select an action to maximize a future reward.

According to one embodiment, the machine learning based engine is trained to determine whether two database records are duplicates with each other. The method further comprises using the machine learning based engine after being trained to compare records of a database. For example, the resulting trained machine learning based engine of each iteration may be used to perform inference.

A data record or record is a collection of related data items such as a name, date of birth and class of a particular user. A record represents an entity, wherein an entity refers to a user, object, or concept about which information is stored in the record. The terms “data record” and “record” are interchangeably used. The data records may be stored in a graph database as entities with relationships, where each record may be assigned to a node or vertex of the graph with properties being attribute values such as name, date of birth etc. The data records may, in another example, be records of a relational database.

The present subject matter may be advantageous as it may enable an accurate classification of data points while saving processing resources by leveraging an active learning technique using improved data for training.

According to one embodiment, the machine learning based engine is used to compare the records of the database if the prediction accuracy of the current trained machine learning based engine does not increase compared to the prediction accuracy of the trained the machine learning based engine of the last iteration. This may ensure that the most accurate classification results are obtained based on current available data. For example, this may enable to predict data point classes with a very high probability, because the trained machine learning based engine may have learned well the classification of the data points. The accuracy may be determined using a testing set. The testing set may be different from the training set. The testing set may comprise data points labelled by a user e.g., real-life data. The trained machine learning based engine may classify (or predict the class of) the data points of the testing set and the fraction of correctly classified data points may be the prediction accuracy.

According to one embodiment, the machine learning based engine is used to compare the records of the database, if the first fraction is zero. That is, the inference may be performed only with an engine that has been trained with real-life data. This may particularly be advantageous in case the required accuracy for the prediction is very high.

According to one embodiment, the method further comprises reducing the synthetic training data in each iteration, thereby further reducing the first fraction of synthetic training data.

For example, the current training dataset may be defined as Dₜᵣₐᵢₙ^{ti}=N_{synthetic}^{ti}+N_{real-life}^{ti}, where i refers to the current i^{th} execution of the training step, Dₜᵣₐᵢₙ^{t1} is the number of data points in the synthetic training data and N_{real-life}^{ti} is the number of data points in the real-life training data. This embodiment may enable to reduce the number of synthetic labeled data points N_{synthetic}^{ti} and increase the number of real-life labeled data points N_{real-life}^{ti} in each iteration of the at least part of the iterations. This may particularly be advantageous in case the amount by which the number of real-life labeled data points N_{real-life}^{ti} is increased is very high because the updated training dataset may still have enough entries even after reducing the synthetic data. This embodiment may enable to improve the accuracy of the predictions of the trained machine learning based engine because it is based on more real-life data.

According to one embodiment, the reduction of the synthetic training data is an absolute or relative reduction. For example, the number N_{synthetic}^{ti} of data points of the synthetic training data may be reduced by a given number Nₓ or may be reduced by a fraction x %. For example, the reduction may be performed as N_{synthetic}^{ti}−Nₓ or as N_{synthetic}^{ti}−x % of N_{synthetic}^{ti}.

According to one embodiment, the reduction of the synthetic training data includes gradually reducing the amount of synthetic data. For example, the fraction of reduction x % may gradually increase e.g., in the first reduction x %=10%, in the second reduction x %=15% and so on.

According to one embodiment, the level of reduction of the synthetic data used for training is dynamically adjusted based on at least one prediction quality metric. The metric may, for example, be the accuracy of the prediction of the trained engine. If the accuracy slightly changes in the current iteration compared to the last iteration, the reduction for the next iteration may be smaller than the last reduction. For example, in the first reduction x %=10% based on the metric, in the second reduction x %=5% based on the metric and so on.

According to one embodiment, the amount of synthetic data is reduced up to a point where the training process runs solely on real-life data.

According to one embodiment, the second fraction is zero in the first execution of the training. The second fraction is zero means that no data is labeled yet by the user. This may enable to use the training from scratch e.g., as soon as the computer system is delivered to the customer.

According to one embodiment, the machine learning based engine is a machine learning based matching engine for finding duplicates in databases, the training dataset comprising labeled records, wherein the records of the synthetic training data are labeled by a rule-based matching engine based on a comparison of the records by the rule-based matching engine.

According to one embodiment, the rule-based matching engine operates using deterministic matching and/or probabilistic matching.

According to one embodiment, the generation of synthetic training data (e.g., the labeling of the records) by the rule-based matching engine is performed using a default configuration of the rule-based matching engine. In another example, the synthetic training data may be generated for different configurations of the rule-based matching engine. This may enable to obtain a large training set that can reliably be used to the train the machine learning based engine.

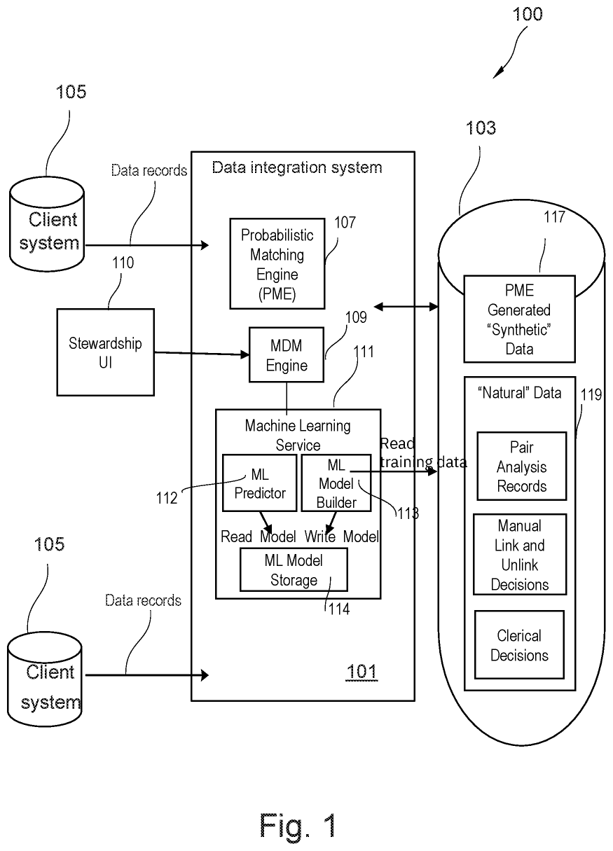

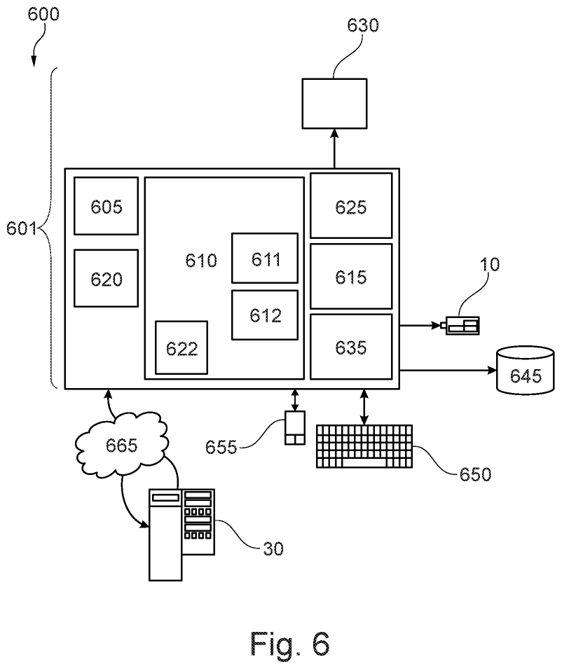

FIG. 1 depicts an exemplary computer system 100. The computer system 100 may, for example, be configured to perform master data management and/or data warehousing e.g., the computer system 100 may enable a de-duplication system. The computer system 100 comprises a data integration system 101 and one or more client systems or data sources 105. The client system 105 may comprise a computer system (e.g., as described with reference to FIG. 6). The data integration system 101 may control access (read and write accesses etc.) to a database system 103.

The client systems 105 may communicate with the data integration system 101 via a network connection which comprises, for example, a wireless local area network (WLAN) connection, WAN (Wide Area Network) connection LAN (Local Area Network) connection or a combination thereof.

Data integration system 101 may process records received from client systems 105 and store the data records into the database system 103. The data records stored in the database repository 103 may have a predefined data structure such as a data table with multiple columns and rows. The predefined data structure may comprise a set of attributes (e.g., each attribute representing a column of the data table). In another example, the data records may be stored in a graph database as entities with relationships. The predefined data structure may comprise a graph structure where each record may be assigned to a node of the graph.

For example, the client systems 105 may be configured to provide or create data records. Each client system 105 may be configured to send the created data records to the data integration system 101 in order to be stored on the database system 103. For example, a client system 105 may be configured to provide records in XML or JSON format or other formats that enable to associate attributes and corresponding attribute values, wherein at least part of the attributes are associated in the XML with respective values.

In one example, data integration system 101 may import data records from a client system 105 using one or more Extract-Transform-Load (ETL) batch processes or via HyperText Transport Protocol (“HTTP”) communication or via other types of data exchange. The data integration system 101 and/or client systems 105 may be associated with, for example, Personal Computers (PC), servers, and/or mobile devices.

Each data record received from client systems 105 by the data integration system 101 may or may not have all values of the set of attributes e.g., a data record may have values of a subset of attributes of the set of attributes and may not have values for the remaining attributes. Once stored in the repository 103, the remaining attributes having no values may be maintained empty in one example. In other terms, the records provided by the client systems 105 have different completeness. The completeness is the ratio of number of attributes of a data record comprising data values to a total number of attributes in the set of attributes.

The data integration system 101 may be configured to process the records of the database system 103 using one or more algorithms. For example, the data integration system 101 may comprise a probabilistic matching engine 107 that is configured to compare or match records and determine whether the compared records are duplicate with each other. The result of this matching may be used to generate synthetic training data 117 that may be stored in the database system 103. The synthetic data 117 comprises labeled data points. A data point refers to two or more records. The label of a data point may be “same” or “different”, meaning that the records of the data point represent the same entity or different entities respectively, e.g., a data point may comprise records of a same person X or records belonging to different persons. In other words, a labeled data point is a data point associated with a class (e.g., “same” or “different”) that resulted from the classification of the data point. This synthetic training data 117 is so named as it is not generated by a user, rather it is generated by the probabilistic matching engine 107. Therefore, synthetic training data 117 is referred to as system defined data. The synthetic training data 117 may, for example, be automatically created by the probabilistic matching engine 107.

The data integration system 101 may further comprise an MDM engine 109. The MDM engine 109 is configured to communicate with users of the data integration system 101 via a user interface 110. In particular, the MDM engine 109 is configured to prompt the user to provide an indication whether two records are duplicate records or not. This prompting may be performed in different contexts. In one first example, the user may be prompted to compare records as a clerical task. In one second example, the user may be prompted to compare records as part of an analysis. In one third example, the user may be prompted to double check a previous matching result. In all cases, the user may provide e.g., via the UI 110 the class of one or more data points. This may result in another training data referred to as real-life training data or natural training data 119. The real-life training data 119 comprises data points labeled by the user; thus, referred to as user defined training data. The real-life training data 119 is stored in the database system 103. FIG. 1 illustrates that the real-life training data 119 is obtained in different contexts according to the first, second and third examples.

The data integration system 101 may further comprise a machine learning service 111. The machine learning service 111 comprises a ML predictor 112 and a ML model builder 113. The ML model builder 113 is configured to train a ML model with the training data 117 and/or 119 in order to provide a trained model that is configured to predict whether records of an input data point are same or different. The ML model may, for example, be stored in the ML model storage 114. The ML predictor 112 is configured to use the stored ML model to perform matching of records e.g., on request by the MDM engine 109.

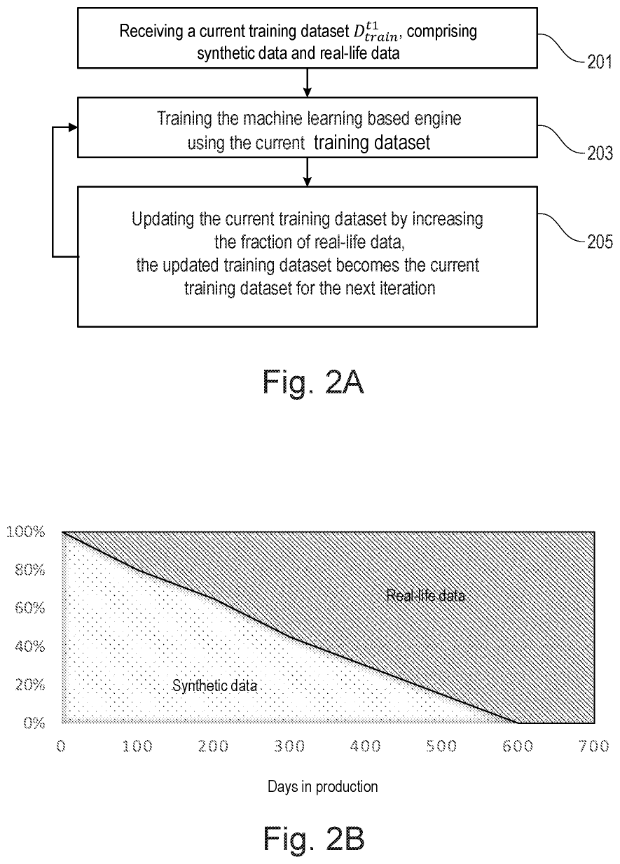

FIG. 2A is a flowchart of a method for training a machine learning based engine in accordance with an example of the present subject matter. For the purpose of explanation, the method may be implemented in the computer system 100 illustrated in previous FIG. 1 such that the trained engine machine learning based engine may classify records, but is not limited to this implementation as the machine learning based engine can be used to perform other classifications. The method may, for example, be performed by the data integration system 101.

The ML model builder 113 may, for example, receive a current training dataset Dₜᵣₐᵢₙ^{t1} in step 201. The current training dataset Dₜᵣₐᵢₙ^{t1} may, for example, be read from the database system 103 at once and then stored locally or may be read from the database system 103 while the training is being performed. The current training dataset Dₜᵣₐᵢₙ^{t1} comprises system labeled records of the synthetic data 117 and user labeled records of the real-life training data 119. The current training dataset Dₜᵣₐᵢₙ^{t1} in represents the current content e.g., at time t1 of the synthetic training data 117 and real-life training data 119 in the database system 103. For example, the current training dataset Dₜᵣₐᵢₙ^{t1} in comprises, at time t1, N_{synthetic}^{t1} labeled data points of the synthetic training data 117 and N_{real-life}^{t1} labeled data points of the real-life training data 117. In other words, Dₜᵣₐᵢₙ^{t1}=N_{synthetic}^{t1}+N_{real-life}^{t1}. That is, a first fraction F_{synthetic}^{t1} of the training dataset comprises the synthetic training data and a remaining second fraction F_{real-life}^{t1} of the training dataset comprising real-life training data, wherein

$${F}_{synthetic}^{t 1} = \frac{{N}_{synthetic}^{t 1}}{{N}_{synthetic}^{t 1} + {N}_{real - life}^{t 1}} and {F}_{real - life}^{t 1} = \frac{{N}_{real - life}^{t 1}}{{N}_{synthetic}^{t 1} + {N}_{real - life}^{t 1}} .$$

The machine learning based engine may be trained in step 203 using the current training dataset Dₜᵣₐᵢₙ^{t1}.

After or while training the machine learning based engine, further real-life training data may be added in step 205 to the existing real-life training data 119. E.g., the users may have performed further clerical tasks that end up with new user labelled data points. This may result in a new increased number of real-life labeled data points N_{real-life}^{t2}, i.e., N_{real-life}^{t2}>N_{real-life}^{t1}. This may define an updated training dataset Dₜᵣₐᵢₙ^{t2}. The updated training dataset Dₜᵣₐᵢₙ^{t2} may become the current training dataset for the next training of the machine learning based engine.

In one example, the updated training set may be defined as Dₜᵣₐᵢₙ^{t2}=+N_{synthetic}^{t1}+N_{real-life}^{t2}, meaning that the updated training set Dₜᵣₐᵢₙ^{t2} in is obtained by adding the new real-life labeled data points to the last training set Dₜᵣₐᵢₙ^{t1}. This may result in a new first fraction F_{synthetic}^{t2} that is smaller than the previous first fraction F_{synthetic}^{t1} and in a new second fraction F_{real-life}^{t2} that is higher than the previous second fraction F_{real-life}^{t1}.

In another example, the updated training set may be defined as Dₜᵣₐᵢₙ^{t2}=N_{synthetic}^{t2}+N_{real-life}^{t2}, wherein N_{synthetic}^{t2} is the new number of labeled synthetic data points that may be obtained by reducing the previous number N_{synthetic}^{t1} of labeled synthetic data points i.e., N_{synthetic}^{t2}<N_{synthetic}^{t1}. This may further reduce the previous first fraction F_{synthetic}^{t1} and further increase the previous second fraction F_{real-life}^{t1}.

The updated training dataset Dₜᵣₐᵢₙ^{t2} of step 205 may be used to train again the machine learning based engine in step 203 of the next iteration/repetition of the training. As indicated in FIG. 2A, steps 203 to 205 may be repeated multiple times. The repetition may, for example, be performed until the first fraction becomes zero, F_{synthetic}^{tn}=0. In another example, the repetition may be performed until the prediction accuracy by the machine learning based engine reaches or exceeds a predefined minimum accuracy threshold.

The method of FIG. 2A may, for example, be executed automatically. FIG. 2B illustrates an example of the evolution of the first fraction of synthetic data (illustrated by the area of dots) and the second fraction of the real-life data (illustrated by the area with lines) that resulted from the method of FIG. 2A. It illustrates the case where a customer starts to work with an MDM system and no labeled training data that was generated through data stewards exists yet, e.g., day 0 in the plot. At this point the rule-based PME engine may be used to create synthetic training data. This data is used to train the machine learning based engine. Over time, more and more real-life data is captured during the stewardship process. The training process may be executed always on the entire set of real-life data. Initially, there is not enough data to train a high quality model. A subset of the synthetic data may be combined with the real-life data for training. Over time the amount of synthetic data is reduced up to a point where the training process runs solely on real-life data.

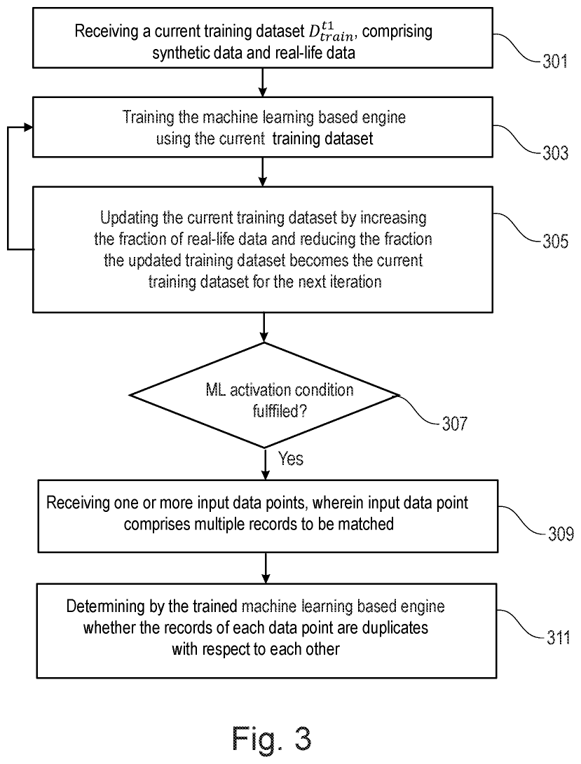

FIG. 3 is a flowchart of a method for matching data records of a dataset in accordance with an example of the present subject matter. For the purpose of explanation, the method may be implemented in the computer system 100 illustrated in previous FIG. 1, but is not limited to this implementation. The method may, for example, be performed by the data integration system 101.

Steps 301 to 305 are steps 201 to 205 of FIG. 2A respectively. The method of FIG. 3 further comprises an inquiry step 307 for determining whether an ML activation condition is fulfilled. The ML activation condition may comprise that the number of times the machine learning based engine has been trained is higher than a threshold. In another example, the ML activation condition may comprise that the prediction accuracy of the machine learning based engine is higher than a minimum accuracy value. In another example, the ML activation condition may comprise that the machine learning based engine has been successfully trained.

The trained machine learning based engine may receive in step 309 one or more input data points, wherein each input data point comprises multiple records. The trained machine learning based engine may provide in step 311 for each input data point a prediction whether the records of the data points are duplicate records or not duplicate records.

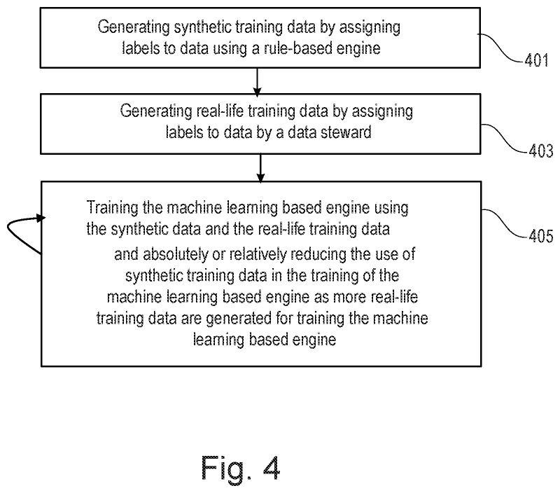

FIG. 4 is a flowchart of a method for training a machine learning based engine in accordance with an example of the present subject matter. For the purpose of explanation, the method may be implemented in the computer system 100 illustrated in previous FIG. 1 such that the trained engine machine learning based engine may match or compare records, but is not limited to this implementation as the machine learning based engine can be used to perform other classifications. The method may, for example, be performed by the data integration system 101.

A synthetic training data may be generated in step 401 by assigning labels to data using a rule-based engine 107. A real-life training data may be generated in step 403 by assigning labels to data by a data steward. The machine learning based engine may be trained in step 405 by using the synthetic data and the real-life training data. As indicated in FIG. 4, the training may be repeated, wherein the use of synthetic training data in the training of the machine learning based engine may absolutely or relatively be reduced as more real-life training data are generated for the training of the machine learning based engine.

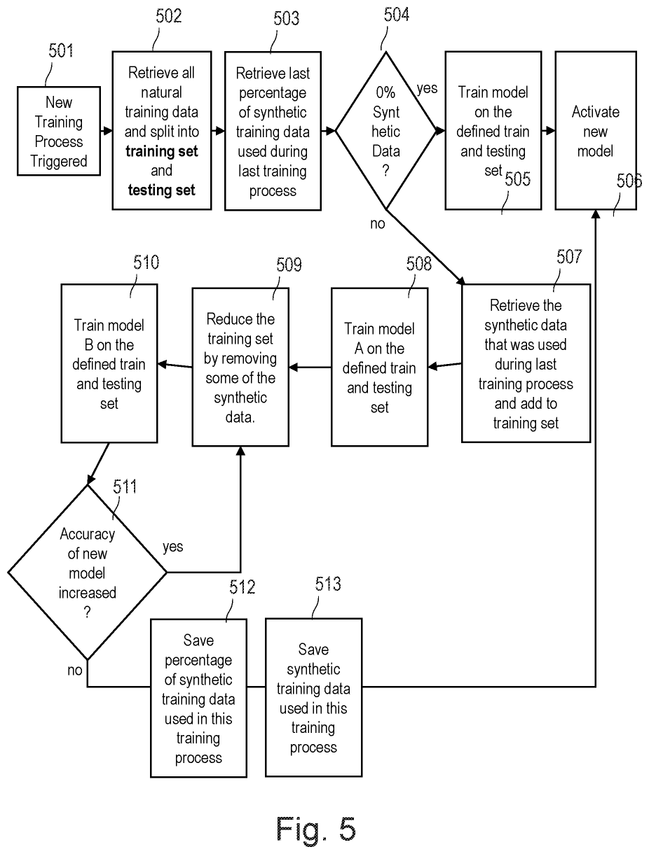

FIG. 5 is a flowchart of a method for inferring a machine learning based engine in accordance with an example of the present subject matter.

A new training process of the machine learning based engine may be triggered in step 501. All natural training data may be retrieved in step 502 and split into training set and testing set. The last percentage of synthetic training data used during last training process may be retrieved in step 503. It may be determined (step 504) whether the percentage of synthetic data is 0%. If the percentage of synthetic data is 0%, the machine learning based engine may be trained on the defined training set and tested on the testing set in step 505. And the machine learning based engine may be activated in step 506 e.g., as a new model for performing inference.

If the percentage of synthetic data is different from 0%, the synthetic data that was used during last training process may be retrieved in step 507 and added to the training set. The machine learning based engine may be trained in step 508 (model A) on the defined training set and tested on the testing set. The training set may be reduced in step 509 by removing some of the synthetic data. The machine learning based engine may be trained in step 510 (model B) on the defined training set and tested using the testing set. It may be determined (step 511) whether the accuracy of the machine learning based engine has increased compared to the machine learning based engine trained at step 508. Models A and B are named differently as they refer to different states of the same trained machine learning based engine. Indeed, since the data being used for training model A is different from data used to train the model B the trainable parameter values of the two models A and B may be different; however, both Models A and B are configured to classify records as duplicate or not. If the accuracy is increased, steps 509 to 511 may be repeated. If the accuracy did not increase, the percentage of synthetic training data used in this training process may be saved in step 512. The synthetic training data used in this training process may be saved in step 513. And the machine learning based engine may be activated in step 506. The accuracy may, for example, be determined by inferring or testing the models A and B using pre-classified records of the testing set. The fraction of correctly classified records of the pre-classified records may be an indication of the accuracy. The pre-classified records of the testing set may be different from the training dataset and may be classified by a user e.g., steward.

FIG. 6 represents a general computerized system 600 suited for implementing at least part of method steps as involved in the disclosure.

It will be appreciated that the methods described herein are at least partly non-interactive, and automated by way of computerized systems, such as servers or embedded systems. In exemplary embodiments though, the methods described herein can be implemented in a (partly) interactive system. These methods can further be implemented in software 612, 622 (including firmware 622), hardware (processor) 605, or a combination thereof. In exemplary embodiments, the methods described herein are implemented in software, as an executable program, and is executed by a special or general-purpose digital computer, such as a personal computer, workstation, minicomputer, or mainframe computer. The most general system 600 therefore includes a general-purpose computer 601.

In exemplary embodiments, in terms of hardware architecture, as shown in FIG. 6, the computer 601 includes a processor 605, memory (main memory) 610 coupled to a memory controller 615, and one or more input and/or output (I/O) devices (or peripherals) 10, 645 that are communicatively coupled via a local Input/Output controller 635. The Input/Output controller 635 can be, but is not limited to, one or more buses or other wired or wireless connections, as is known in the art. The Input/Output controller 635 may have additional elements, which are omitted for simplicity, such as controllers, buffers (caches), drivers, repeaters, and receivers, to enable communications. Further, the local interface may include address, control, and/or data connections to enable appropriate communications among the aforementioned components. As described herein the I/O devices 10, 645 may generally include any generalized cryptographic card or smart card known in the art.

The processor 605 is a hardware device for executing software, particularly that stored in memory 610. The processor 605 can be any custom made or commercially available processor, a central processing unit (CPU), an auxiliary processor among several processors associated with the computer 601, a semiconductor-based microprocessor (in the form of a microchip or chip set), or generally any device for executing software instructions.

The memory 610 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM). Note that the memory 610 can have a distributed architecture, where various components are situated remote from one another, but can be accessed by the processor 605.

The software in memory 610 may include one or more separate programs, each of which comprises an ordered listing of executable instructions for implementing logical functions, notably functions involved in embodiments of this invention. In the example of FIG. 6, software in the memory 610 includes instructions 612 e.g., instructions to manage databases such as a database management system.

The software in memory 610 shall also typically include a suitable operating system (OS) 411. The OS 611 essentially controls the execution of other computer programs, such as possibly software 612 for implementing methods as described herein.

The methods described herein may be in the form of a source program 612, executable program 612 (object code), script, or any other entity comprising a set of instructions 612 to be performed. When a source program, then the program needs to be translated via a compiler, assembler, interpreter, or the like, which may or may not be included within the memory 610, so as to operate properly in connection with the OS 611. Furthermore, the methods can be written as an object-oriented programming language, which has classes of data and methods, or a procedure programming language, which has routines, subroutines, and/or functions.

In exemplary embodiments, a conventional keyboard 650 and mouse 655 can be coupled to the Input/Output controller 635. Other output devices such as the I/O devices 645 may include input devices, for example but not limited to a printer, a scanner, microphone, and the like. Finally, the I/O devices 10, 645 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The I/O devices 10, 645 can be any generalized cryptographic card or smart card known in the art. The system 600 can further include a display controller 625 coupled to a display 630. In exemplary embodiments, the system 600 can further include a network interface for coupling to a network 665. The network 665 can be an IP-based network for communication between the computer 601 and any external server, client and the like via a broadband connection. The network 665 transmits and receives data between the computer 601 and external systems 30, which can be involved to perform part, or all of the steps of the methods discussed herein. In exemplary embodiments, network 665 can be a managed IP network administered by a service provider. The network 665 may be implemented in a wireless fashion, e.g., using wireless protocols and technologies, such as Wi-Fi, WiMAX, etc. The network 665 can also be a packet-switched network such as a local area network, wide area network, metropolitan area network, Internet network, or other similar type of network environment. The network 665 may be a fixed wireless network, a wireless local area network W(LAN), a wireless wide area network (WWAN) a personal area network (PAN), a virtual private network (VPN), intranet or other suitable network system and includes equipment for receiving and transmitting signals.

If the computer 601 is a PC, workstation, intelligent device or the like, the software in the memory 610 may further include a basic input output system (BIOS) 622. The BIOS is a set of essential software routines that initialize and test hardware at startup, start the OS 611, and support the transfer of data among the hardware devices. The BIOS is stored in ROM so that the BIOS can be executed when the computer 601 is activated.

When the computer 601 is in operation, the processor 605 is configured to execute software 612 stored within the memory 610, to communicate data to and from the memory 610, and to generally control operations of the computer 601 pursuant to the software. The methods described herein and the OS 611, in whole or in part, but typically the latter, are read by the processor 605, possibly buffered within the processor 605, and then executed.

When the systems and methods described herein are implemented in software 612, as is shown in FIG. 6, the methods can be stored on any computer readable medium, such as storage 620, for use by or in connection with any computer related system or method. The storage 620 may comprise a disk storage such as HDD storage.

The subject matter of the present disclosure can include the following. In an aspect 1 according to the present disclosure, a computer implemented method of training a machine learning based engine includes: receiving a current training dataset, a first fraction of the current training dataset comprising synthetic training data and a remaining second fraction of the training dataset comprising real-life training data, the real-life training data being user defined data and the synthetic training data being system defined data; and repeatedly training the machine learning based engine by using the current training dataset, wherein the training dataset is updated in each iteration (iteration refers to repetition of the training) or in each iteration of a subset of the iterations by adding real-life training data, thereby increasing the second fraction of the real-life training data and reducing the first fraction of the synthetic training data in the updated training dataset.

In a second aspect of the method above the machine learning based engine is trained to determine whether two data records are duplicates with each other, the method further comprising using the machine learning based engine after being trained to compare records of a database.

In a third aspect of the method above the machine learning based engine is used to compare the records of the database if a prediction accuracy of the current trained the machine learning based engine does not increase compared to the prediction accuracy of the trained the machine learning based engine of the last iteration.

In a fourth aspect of the method above wherein in an aspect 3 the machine learning based engine is used to compare the records of the database if the first fraction is zero.

In a fifth aspect of the method above, which includes any of the preceding second through third aspects, in each iteration or in each iteration of the subset of the iterations reduces the synthetic training data, thereby further reducing the first fraction of synthetic training data in the updated training dataset.

A sixth aspect of the method above includes the fifth aspect wherein the reduction of the synthetic training data is an absolute or relative reduction.

A seventh aspect of the method above includes the fifth or sixth aspects wherein the repeated reducing of the synthetic training data includes gradually reducing the amount of synthetic data.

An eighth aspect of the method above, includes any of the fifth through seventh aspects wherein the amount of synthetic data is reduced up to a point where the training is performed solely on real-life training data.

In a ninth aspect of the method above, any of the preceding first through eighth aspects, include the second fraction being zero for the first execution of the training of the machine learning based engine.

A tenth aspect, includes the method above, wherein the machine learning based engine is a machine learning based matching engine for finding duplicates in databases, the training dataset comprising labeled records, wherein the records of the synthetic training data are labeled by a rule-based matching engine based on a comparison of the records by the rule-based matching engine.

In an eleventh aspect of the method above, the tenth aspect includes the rule-based matching engine operating using deterministic matching and/or probabilistic matching.

In a twelfth aspect of the method above, any one of the tenth and eleventh aspects can include the generating of synthetic training data including using a default configuration of the rule-based matching engine.

In a thirteenth aspect of the method above, any of the preceding fifth to twelfth aspects can include the level of reduction of the synthetic data used for training being dynamically adjusted based on at least one prediction quality metric.

In another embodiment according to the present disclosure, a computer program product comprises a computer-readable storage medium having computer-readable program code embodied therewith. The computer-readable program code is configured to implement the method above.

In another embodiment according to the present disclosure, a computer system can include training a machine learning based engine. The computer system is configured for: receiving a current training dataset, a first fraction of the training dataset comprising synthetic training data and a remaining second fraction of the training dataset comprising real-life training data, the real-life training data being user defined data and the synthetic training data being system defined data; repeatedly training the machine learning based engine by using the current training dataset, wherein the training dataset is updated in each iteration or in each iteration of a subset of the iterations by adding real-life training data, thereby increasing the second fraction in the updated training dataset and reducing the first fraction of the synthetic training data.

In one aspect according to the present disclosure, a computer implemented method of training a machine learning based engine includes receiving a current training dataset. A first fraction of the training dataset includes synthetic training data and a remaining second fraction of the training dataset comprising real-life training data, the real-life training data being user defined data and the synthetic training data being system defined data. The method includes repeatedly training the machine learning based engine by using the current training dataset. Each iteration (or repetition) of at least part of the iterations the training dataset is updated by adding real-life training data, thereby increasing the second fraction in the updated training dataset and reducing the first fraction of the synthetic training data.

In another aspect according to the present disclosure, a computer implemented method of training a machine learning based engine includes receiving a current training dataset. A first fraction of the current training dataset comprising synthetic training data and a remaining second fraction of the training dataset comprising real-life training data, the real-life training data being user defined data and the synthetic training data being system defined data. The method includes repeatedly training the machine learning based engine by using the current training dataset, wherein the training dataset is updated in each iteration or in each iteration of a subset of the iterations by adding real-life training data, thereby increasing the second fraction of the real-life training data and reducing the first fraction of the synthetic training data in the updated training dataset.

In another aspect according to the present disclosure, a computer program product includes a computer-readable storage medium having computer-readable program code embodied therewith, and the computer-readable program code is configured to implement the operations of the method according to preceding embodiments.

In another aspect according to the present disclosure, a computer system for training a machine learning based engine includes receiving a current training dataset, a first fraction of the training dataset comprising synthetic training data and a remaining second fraction of the training dataset comprising real-life training data. The real-life training data is user defined data and the synthetic training data being system defined data. The system includes repeatedly training the machine learning based engine by using the current training dataset, wherein in each iteration (or repetition) of at least part of the iterations the training dataset is updated by adding real-life training data, thereby increasing the second fraction in the updated training dataset and reducing the first fraction of the synthetic training data.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer implemented method of training a machine learning based engine, the method comprising:
receiving a current training dataset, a first fraction of the current training dataset comprising synthetic training data and a remaining second fraction of the training dataset comprising real-life training data, the real-life training data being user defined data and the synthetic training data being system defined data; and
repeatedly training the machine learning based engine by using the current training dataset, wherein the training dataset is updated in each iteration or in each iteration of a subset of the iterations by adding real-life training data, thereby increasing the second fraction of the real-life training data and reducing the first fraction of the synthetic training data in the updated training dataset.

2. The method of claim 1, the machine learning based engine being trained to determine whether two data records are duplicates with each other, the method further comprising using the machine learning based engine after being trained to compare records of a database.

3. The method of claim 2, wherein the machine learning based engine is used to compare the records of the database if a prediction accuracy of the current trained machine learning based engine does not increase compared to the prediction accuracy of the trained machine learning based engine of the last iteration.

4. The method of claim 2, wherein the machine learning based engine is used to compare the records of the database if the first fraction is zero.

5. The method of claim 1, further comprising: in each iteration or in each iteration of the subset of the iterations reducing the synthetic training data, thereby further reducing the first fraction of synthetic training data in the updated training dataset.

6. The method of claim 5, wherein the reduction of the synthetic training data is an absolute or relative reduction.

7. The method of claim 5, wherein the repeated reduction of the synthetic training data includes gradually reducing the amount of synthetic training data.

8. The method of claim 5, wherein the amount of synthetic training data is reduced up to a point where the training is performed solely on real-life training data.

9. The method of claim 5, wherein the level of reduction of the synthetic training data used for training is dynamically adjusted based on at least one prediction quality metric.

10. The method of claim 1, the second fraction being zero for the first execution of the training of the machine learning based engine.

11. The method of claim 1, wherein the machine learning based engine is a machine learning based matching engine for finding duplicates in databases, the training dataset comprising labeled records, wherein the records of the synthetic training data are labeled by a rule-based matching engine based on a comparison of the records by the rule-based matching engine.

12. The method of claim 11, wherein the rule-based matching engine operates using deterministic matching and/or probabilistic matching.

13. The method of claim 11, wherein labeling synthetic training records includes using a default configuration of the rule-based matching engine.

14. A computer program product comprising a computer readable storage medium having program instructions embodied therewith, the program instructions executable by a computer to cause the computer to perform functions, by the computer, comprising the functions to;
receive a current training dataset, a first fraction of the current training dataset comprising synthetic training data and a remaining second fraction of the training dataset comprising real-life training data, the real-life training data being user defined data and the synthetic training data being system defined data; and
repeatedly train the machine learning based engine by using the current training dataset, wherein the training dataset is updated in each iteration or in each iteration of a subset of the iterations by adding real-life training data, thereby increasing the second fraction of the real-life training data and reducing the first fraction of the synthetic training data in the updated training dataset.

15. The computer program product of claim 14, the machine learning based engine being trained to determine whether two data records are duplicates with each other, the method further comprising using the machine learning based engine after being trained to compare records of a database.

16. The computer program product of claim 15, wherein the machine learning based engine is used to compare the records of the database if a prediction accuracy of the current trained machine learning based engine does not increase compared to the prediction accuracy of the trained machine learning based engine of the last iteration.

17. The computer program product of claim 15, wherein the machine learning based engine is used to compare the records of the database if the first fraction is zero.

18. The computer program product of claim 14, further comprising: in each iteration or in each iteration of the subset of the iterations reducing the synthetic training data, thereby further reducing the first fraction of synthetic training data in the updated training dataset.

19. The computer program product of claim 18, wherein the reduction of the synthetic training data is an absolute or relative reduction.

20. A system of training a machine learning based engine including a computer system, the computer system comprising; a computer processor, a computer-readable storage medium, and program instructions stored on the computer-readable storage medium being executable by the processor, to cause the computer system to perform the following functions to;
receive a current training dataset, a first fraction of the training dataset comprising synthetic training data and a remaining second fraction of the training dataset comprising real-life training data, the real-life training data being user defined data and the synthetic training data being system defined data; and
repeatedly train the machine learning based engine by using the current training dataset, wherein the training dataset is updated in each iteration or in each iteration of a subset of the iterations by adding real-life training data, thereby increasing the second fraction in the updated training dataset and reducing the first fraction of the synthetic training data.
